(19) United States
(12) Patent Application Publication
(10) Pub. No.: US 2026/0176108 A1
(43) Pub. Date: Jun. 25, 2026

(54) WORK MACHINE

(71) Applicant: SUMITOMO HEAVY INDUSTRIES, LTD., Tokyo (JP)

(72) Inventors: Yasuhiro YAMAMOTO, Kanagawa (JP); Keita NAKAMORI, Kanagawa (JP); Ryosuke KURAMOCHI, Kanagawa (JP); Hisashi OSUMI, Tokyo (JP)

(21) Appl. No.: 19/419,612

(22) Filed: Dec. 15, 2025

(30) Foreign Application Priority Data
Dec. 20, 2024 (JP) 2024-225499

(51) Int. Cl. B66C 13/06

(52) U.S. Cl. CPC B66C 13/063; B66C 2700/0371

(57) ABSTRACT

A work machine is provided and includes a wire rope including a lower end configured to hold a suspended load; and a suspending fulcrum configured to suspend the wire rope and to be movable. In a case in which the lower end of the wire rope is moved in a horizontal direction from a first position, which is previously set, to a second position, the work machine is configured to perform control to maintain, from the first position to a position close to the second position, a state in which the suspending fulcrum leads the lower end of the wire rope, and the lower end of the wire rope follows the suspending fulcrum.

### CROSS-REFERENCE TO RELATED APPLICATIONS

This application is based upon and claims priority to Japanese Patent Application No. 2024-225499, filed on Dec. 20, 2024, the entire contents of which are incorporated herein by reference.

### BACKGROUND

### 1. Technical Field

The present disclosure relates to a work machine.

### 2. Description of Related Art

In recent years, a technique of automatically controlling a suspended load suspended from a wire rope along a target trajectory has been developed in a crane, which is a work machine. However, the crane may be unable to stably transfer the suspended load due to the sway of the suspended load during transfer. Therefore, it is desirable to provide a technique that can perform automatic control while suppressing the sway of the suspended load.

For example, related art discloses a technique that combines a plurality of straight paths when transferring a suspended load. Also, the related art discloses a technique that, when a set straight path passes inside an arc region having the minimum radius of work of a crane, combines the straight path and an arc path for passage on the arc.

However, for example, when an obstacle or the like exists, the technique disclosed in the related art forms a complicated path and frequently performs switching between the straight line and the arc. As a result, the suspended load suspended by a wire rope (i.e., the lower end of the wire rope) may easily sway during switching between a straight-line motion and an arc motion. That is, sway cannot be sufficiently suppressed only by combining the straight path and the arc path in the target trajectory and moving the wire rope along the resulting trajectory. Therefore, regarding control of the movement of the wire rope, there is a need for a technique that can sufficiently suppress the sway of the suspended load.

### SUMMARY

According to an aspect of the present disclosure, a work machine includes: a wire rope including a lower end configured to hold a suspended load; and a suspending fulcrum configured to suspend the wire rope and to be movable. In a case in which the lower end of the wire rope is moved in a horizontal direction from a first position, which is previously set, to a second position, the work machine is configured to perform control to maintain, from the first position to a position close to the second position, a state in which the suspending fulcrum leads the lower end of the wire rope, and the lower end of the wire rope follows the suspending fulcrum.

### BRIEF DESCRIPTION OF THE DRAWINGS

FIG. 1 is a side diagram illustrating an example of a crane according to an embodiment of the present disclosure;

FIG. 2 is a block diagram schematically illustrating an example of a configuration of the crane according to the embodiment;

FIG. 3 is a plan diagram illustrating a movement of a suspending fulcrum of the crane from a start position to a target position;

FIG. 4 is a flowchart illustrating an example of a process through which the target position is registered in a simple operation mode in a controller according to the embodiment;

FIG. 5 is a diagram illustrating an example of a screen of the simple operation mode displayed by a display control part;

FIG. 6 is a flowchart illustrating a process through which the controller performs control of the movement of a boom in the simple operation mode;

FIG. 7 is a plan view illustrating a target trajectory from a start position to a target position TP in the presence of an obstacle;

FIG. 8A is a first explanatory diagram illustrating a relationship between a position of the suspending fulcrum and a position of a suspended load in sway suppression control;

FIG. 8B is a second explanatory diagram illustrating the relationship between the position of the suspending fulcrum and the position of the suspended load in the sway suppression control;

FIG. 8C is a third explanatory diagram illustrating the relationship between the position of the suspending fulcrum and the position of the suspended load in the sway suppression control;

FIG. 9 is an explanatory diagram illustrating a relationship between a slewing axis of the crane and a rising/lowering axis of the crane, and each parameter of the crane;

FIG. 10 is a graph illustrating a change over time in an inclination angle in the movement of the suspending fulcrum;

FIG. 11A is a first motion diagram illustrating a motion of a suspending fulcrum 6S and behaviors of a suspended load HL in stop control;

FIG. 11B is a second motion diagram illustrating the motion of the suspending fulcrum 6S and the behaviors of the suspended load HL in the stop control;

FIG. 11C is a third motion diagram illustrating the motion of the suspending fulcrum 6S and the behaviors of the suspended load HL in the stop control;

FIG. 11D is a fourth motion diagram illustrating the motion of the suspending fulcrum 6S and the behaviors of the suspended load HL in the stop control;

FIG. 11E is a fifth motion diagram illustrating the motion of the suspending fulcrum 6S and the behaviors of the suspended load HL in the stop control;

FIG. 11F is a sixth motion diagram illustrating the motion of the suspending fulcrum 6S and the behaviors of the suspended load HL in the stop control;

FIG. 12 is a graph illustrating an operation that suppresses the suspended load from moving ahead of the suspending fulcrum when, during the movement of the suspension point, the suspended load begins to lead;

FIG. 13 is a graph illustrating a change in an inclination angle, a change in a velocity command value, and a change in a slewing velocity of the suspended load when a follow adjustment is performed in the sway suppression control; and

FIG. 14 is a schematic diagram illustrating a configuration example of a remote control system for the crane according to a modified example of the present disclosure.

### DETAILED DESCRIPTION

The present disclosure provides a technique that can sufficiently suppress the sway of the lower end of a wire rope through control of the movement of the wire rope.

Hereinafter, embodiments of the present disclosure will be described with reference to the drawings. In the drawings, the same components are denoted by the same reference signs, and duplicate description thereof may be omitted. The embodiments described below are exemplary and do not limit the present invention. Features or combinations thereof described in the embodiments are not necessarily essential to the present invention.

### <Overall Configuration of Crane 100>

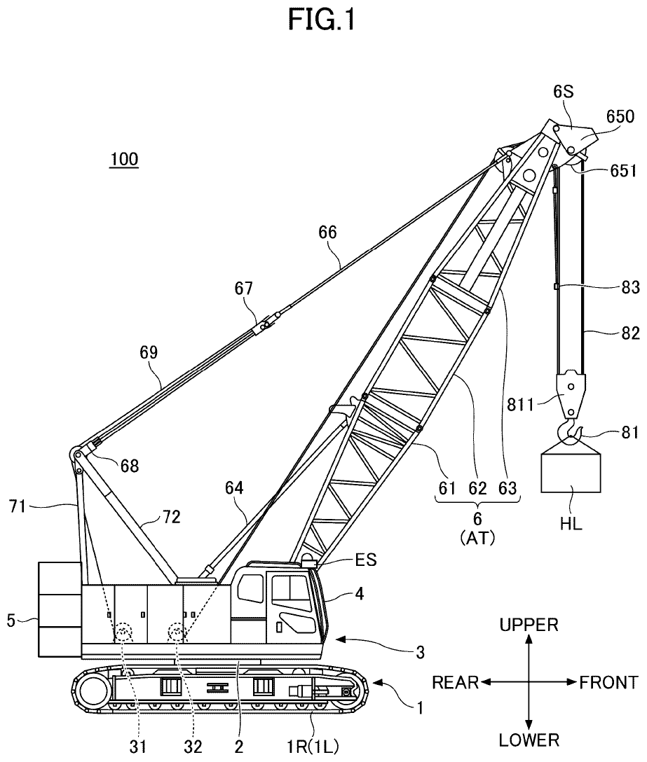

A movable crane 100 illustrated in FIG. 1 will be described as an example of a work machine according to an embodiment of the present disclosure. FIG. 1 is a side diagram illustrating an example of the crane 100 according to the embodiment. In the following, a front-rear direction, a left-right direction, and a top-bottom direction of the crane 100 will be described along a front-rear direction, a left-right direction, and a top-bottom direction as seen from a driver of the crane 100 (hereinafter may be referred to as an operator).

The crane 100 according to the embodiment is what is referred to as a movable crawler crane. The crane 100 includes a self-propelled crawler-type lower driving body 1, an upper slewing body 3 slewably mounted on the lower driving body 1, and an attachment AT attached to the front side of the upper slewing body 3 to be able to be raised and lowered.

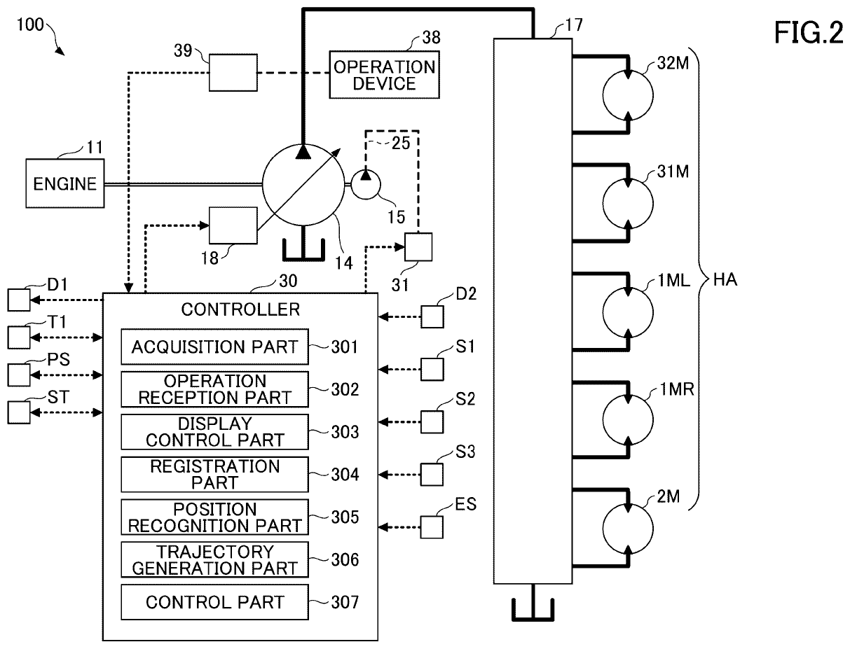

The lower driving body 1 includes, for example, a pair of right and left crawlers 1L and 1R. The lower driving body 1 is configured to propel the crane 100 by the respective crawlers being hydraulically driven by a left driving hydraulic motor 1ML and a right driving hydraulic motor 1MR (see FIG. 2).

The upper slewing body 3 is configured to slew relative to the lower driving body 1 by a slewing mechanism 2 being hydraulically driven by a slewing hydraulic motor 2M (see FIG. 2).

The upper slewing body 3 includes a cab 4 at a position near the right side of the attachment AT. In the cab 4, the operator sits on a seat and operates the crane 100. Also, the upper slewing body 3 includes a counterweight 5, on the rear side, configured to ensure a weight balance relative to the attachment AT and the suspended load.

The attachment AT is configured to suspend and transfer the suspended load. The attachment AT includes a boom 6 including: a lower boom 61 connected to a boom attaching portion of the upper slewing body 3 to be able to be raised and lowered; an intermediate boom 62 connected to the tip of the lower boom 61; and an upper boom 63 connected to the tip of the intermediate boom 62. The boom 6 is formed by assembling a plurality of frames, and thus has sufficient rigidity.

The length of the attachment AT of the boom 6 can be changed by increasing or decreasing the number of the intermediate booms 62 that can be connected to each other. Also, the attachment AT includes a backstop 64 on the rear side of the tip of the lower boom 61. The backstop 64 is configured to regulate a rearward rotation of the boom 6.

Further, the crane 100 includes a pendant rope 66, an upper spreader 67, a lower spreader 68, a boom raising/lowering wire rope 69, a gantry 71, and a gantry ascending/descending cylinder 72.

One end of the pendant rope 66 is connected to the rear side of the tip of the upper boom 63. The other end of the pendant rope 66 is connected to the upper spreader 67. The upper spreader 67 connects the pendant rope 66 and the boom raising/lowering wire rope 69. The boom raising/lowering wire rope 69 is wound around a boom raising/lowering winch 31 provided in the upper slewing body 3. The boom raising/lowering wire rope 69 is wound or unwound in accordance with driving of the boom raising/lowering winch 31.

The lower spreader 68 is attached to the tip of the gantry 71 provided to be able to be raised and lowered relative to the upper slewing body 3. The gantry ascending/descending cylinder 72 is provided at the upper slewing body 3. The gantry ascending/descending cylinder 72 is configured to ascend/descend the gantry 71.

For example, the crane 100 winds the boom raising/lowering wire rope 69 due to the boom raising/lowering winch 31 while allowing the gantry 71 to stand due to the gantry ascending/descending cylinder 72. Thus, the crane 100 pulls the pendant rope 66 through the upper spreader 67, thereby rotating the boom 6 rearward and upward. Conversely, the crane 100 can unwind the boom raising/lowering wire rope 69 due to the boom raising/lowering winch 31, thereby rotating the boom 6 forward and downward.

For holding the suspended load, the crane 100 includes a boom hook 81, a wire rope 82, and a hook overwinding prevention device 83. The boom hook 81 is suspended from the wire rope 82 via a hook bracket 811. In other words, the boom hook 81 forms the lower end of the wire rope 82. The hook bracket 811 includes a pulley (not shown) around which the wire rope 82 is wound.

One end of the wire rope 82 is fixed to a fixed portion provided at the tip of the boom 6. The wire rope 82 extends downward to the hook bracket 811 of the boom hook 81, and turns back from the hook bracket 811 to extend upward. Further, the wire rope 82 is wound around a point sheave 651, provided at the tip of the boom 6, to extend to the rear side of the boom 6, and is wound around a front winch 32, provided in the upper slewing body 3, from the rear side of the tip of the boom 6. Also, the hook overwinding prevention device 83 is provided at the wire rope 82 to define the ascending limit of the boom hook 81.

When the crane 100 winds the wire rope 82 around the front winch 32, the boom hook 81 can ascend to hoist the suspended load. Conversely, when the crane 100 unwinds the wire rope 82 from the front winch 32, the boom hook 81 can descend to lower the suspended load.

Next, a configuration of a drive system and control system of the crane 100 will be described with reference to FIG. 2. FIG. 2 is a block diagram schematically illustrating an example of a configuration of the crane 100 according to the embodiment.

### <Hydraulic Drive System>

A hydraulic drive system of the crane 100 according to the embodiment includes hydraulic actuators HA configured to hydraulically drive the lower driving body 1 (the left and right crawlers), the upper slewing body 3, the attachment AT, and the like. The hydraulic actuator HA includes the driving hydraulic motors 1ML and 1MR, the slewing hydraulic motor 2M, a boom raising/lowering hydraulic motor 31M, a front winch hydraulic motor 32M, and the like.

The slewing hydraulic motor 2M is an actuator configured to slew the upper slewing body 3 relative to the lower driving body 1. The boom raising/lowering hydraulic motor 31M is an actuator configured to drive the boom raising/lowering winch 31. The front winch hydraulic motor 32M is an actuator configured to drive the front winch 32.

The hydraulic drive system of the crane 100 includes an engine 11, a main pump 14, a pilot pump 15, a control valve unit 17, and a regulator 18.

The engine 11 is a prime mover, and a main power source in the hydraulic drive system. The engine 11 is, for example, a diesel engine using diesel as a fuel. The engine 11 is mounted, for example, in a rear portion of the upper slewing body 3. The engine 11 is configured to constantly rotate at a predetermined target rotation speed under the control of a controller 30 described below, and drive the main pump 14 and the pilot pump 15.

The main pump 14 is configured to supply hydraulic oil to the control valve unit 17 through a high-pressure hydraulic line. The main pump 14 is mounted, for example, in the rear portion of the upper slewing body 3, similar to the engine 11. The main pump 14 is, for example, a variable displacement hydraulic pump, and is configured, under the control of the controller 30, to control a discharge flow rate (discharge pressure) of hydraulic oil by the stroke length of a piston being adjusted by the regulator 18 adjusting a tilt angle of a swashplate.

The control valve unit 17 is a hydraulic control device configured to control the hydraulic actuators HA in accordance with the content of an operation or a remote operation performed by the operator on an operation device 38, or in accordance with an operation command regarding an automatic operation function output from the controller 30. The control valve unit 17 is mounted, for example, in a center portion of the upper slewing body 3. The control valve unit 17 is connected to the main pump 14 via a high-pressure hydraulic line, and is configured to selectively supply hydraulic oil, supplied from the main pump 14, to each hydraulic actuator in accordance with an operation performed by the operator or in accordance with an operation command output from the controller 30. Specifically, the control valve unit 17 includes a plurality of control valves (e.g., directional switch valves) configured to control the flow rate and flow direction of hydraulic oil supplied from the main pump 14 to each of the hydraulic actuators HA.

### <Operation System>

An operation system of the crane 100 includes the pilot pump 15, the controller 30, a proportional valve 29, the operation device 38, and an operation sensor 39.

The pilot pump 15 is configured to supply a pilot pressure to various hydraulic devices via a pilot line 25. The pilot pump 15 is mounted, for example, in the rear portion of the upper slewing body 3, similar to the engine 11. The pilot pump 15 is, for example, a fixed displacement hydraulic pump. The pilot pump 15 may be omitted. In this case, hydraulic oil having a relatively low pressure after the hydraulic oil having a relatively high pressure discharged from the main pump 14 is reduced by a predetermined pressure reducing valve, is supplied to the various hydraulic devices as the pilot pressure.

The operation device 38 is provided near an operator's seat of the cab 4, and is used by the operator to perform various operations of the crane 100. The operation device 38 includes a pedal, a lever, or the like, configured to operate each hydraulic actuator HA.

For example, the operation device 38 is configured to be of electric type. The operation sensor 39 is configured to detect the direction and amount of an operation performed by the operator on the operation device 38, and output, to the controller 30, an operation signal corresponding to each operated actuator.

Then, the controller 30 is configured to output, to the proportional valve 29, a control command corresponding to the content of an operation signal, i.e., a control signal corresponding to the content of an operation performed on the operation device 38. Thus, a pilot pressure in accordance with the content of the operation performed on the operation device 38 is input from the proportional valve 29 to the control valve unit 17, and the control valve unit 17 can drive each hydraulic actuator HA in accordance with the content of the operation performed on the operation device 38. A control valve (directional switch valve) configured to drive each hydraulic actuator included in the control valve unit 17 may be of an electromagnetic solenoid type. In this case, an operation signal output from the operation device 38 may be directly input to the control valve unit 17 (control valve of an electromagnetic solenoid type).

The proportional valve 29 is provided for each of the hydraulic actuators HA to be operated by the operation device 38. The proportional valve 29 is disposed in a conduit connecting the pilot pump 15 and the pilot port of the control valve in the control valve unit 17, and is configured to change the flow path area of the conduit. The proportional valve 29 is configured to operate in response to a control command output from the controller 30. Therefore, the controller 30 can supply hydraulic oil discharged from the pilot pump 15 to the control valve of each hydraulic actuator HA provided in the control valve unit 17 via the proportional valve 29, independently of the operation performed by the operator on the operation device 38.

### <User Interface System>

A user interface system of the crane 100 includes the operation device 38, the operation sensor 39, a display device D1, and an input device D2.

The display device D1 is configured to output various information to the operator of the crane 100 in the cab 4. The display device D1 is provided at a place where the display device D1 is easily visible from the operator sitting in the cab 4. The display device D1 is a device configured to output various information in a visible manner, and is, for example, a liquid crystal display, an organic electroluminescence (EL) display, or the like.

The input device D2 is provided in a range close to the operator sitting in the cab 4, and is configured to receive various inputs from the operator. The input signal received by the input device D2 is taken into the controller 30. Examples of the input device D2 include a touch panel mounted in the display device, a touch pad provided around the display device, a button switch, a lever, a toggle, a knob switch provided on the operation device 38 (lever device), and the like. Also, for example, the input device D2 may be a voice input device configured to receive voice input from the operator. Examples of the voice input device include a microphone and the like. Alternatively, the input device D2 may be a gesture input device configured to receive a gesture input from the operator. Examples of the gesture input device include, for example, an imaging device (indoor camera) disposed in the cab 4.

### <Communication System>

A communication system of the crane 100 includes a communication device T1 configured to communicate with an external device. The communication device T1 is connected to a communication line, and is configured to perform communication with a device provided separately from the crane 100. Examples of the device provided separately from the crane 100 include a portable communication terminal carried by a worker existing in the work site. Also, the communication device T1 may include a mobile communication module conforming to a standard, such as 4G (4th Generation), 5G (5th Generation), or the like. Further, for example, the communication device T1 may include a satellite communication module, a Wi-Fi (registered trademark) communication module, a Bluetooth (registered trademark) communication module, or the like.

### <Control System>

A control system of the crane 100 includes, for example, a slewing sensor S1, a boom raising/lowering sensor S2, a length sensor S3, an upper slewing body positioning device PS, a peripheral recognition device ES, a storage device ST, and a controller 30.

The slewing sensor S1 is configured to output information of slewing of the upper slewing body 3. The slewing sensor S1 is configured to detect, for example, a slewing angular velocity of the upper slewing body 3 relative to the lower driving body 1. Further, the slewing sensor S1 is configured to detect a slewing angle. The slewing sensor S1 may be a gyro sensor, a resolver, a rotary encoder, an inertial measurement unit (IMU), or the like. A detection signal corresponding to the slewing angle or the slewing angular velocity of the upper slewing body 3 obtained by the slewing sensor S1 is taken into the controller 30.

The boom raising/lowering sensor S2 is configured to output information of raising/lowering of the boom 6. The boom raising/lowering sensor S2 is configured, for example, to detect the raising/lowering angle (inclination angle) of the boom 6. The boom raising/lowering sensor S2 may be, for example, a gyro sensor, an IMU, or the like. A detection signal corresponding to the raising/lowering angle of the boom 6 obtained by the boom raising/lowering sensor S2 is taken into the controller 30.

The length sensor S3 is configured to output information of the length of the wire rope 82 configured to hoist a suspended load by the boom hook 81. The length sensor S3 is, for example, an encoder provided in the front winch 32, and is configured to detect the length of the wire rope 82 unwound from the front winch 32.

The upper slewing body positioning device PS is configured to measure the position of the upper slewing body 3. The upper slewing body positioning device PS is, for example, a global navigation satellite system (GNSS) positioning device, and is configured to detect the position and direction of the upper slewing body 3. Detection signals corresponding to the position and direction of the upper slewing body 3 are taken into the controller 30. The function of detecting the direction of the upper slewing body 3 may be implemented by an orientation sensor attached to the upper slewing body 3. The upper slewing body positioning device PS is configured to measure the current position of the crane 100 in a reference coordinate system that is set.

The reference coordinate system is, for example, the world geodetic system in which a position on the globe can be specified. The world geodetic system is a three-dimensional orthogonal XYZ coordinate system in which the origin is set at the centroid of the Earth, an X axis is taken in a direction of the intersection between the Greenwich meridian and the equator, a Y axis is taken in a direction of a 90-degree east longitude, and a Z axis is taken in a direction of the North Pole.

The peripheral recognition device ES is disposed, for example, in a front portion of the ceiling of the cab 4, and is configured to acquire peripheral information outside the crane 100. The peripheral recognition device ES is configured by combining one or more of, for example, an imaging device, such as a monocular camera, a stereo camera, or the like, a LiDAR sensor, an ultrasonic sensor, other optical sensors, and the like. The information acquired by the peripheral recognition device ES is converted, through well-known image processing or the like, to information that can be recognized by the controller 30, and is taken into the controller 30. The peripheral recognition device ES may be disposed at any position of the crane 100, for example, at the counterweight 5 or the like.

The storage device ST is, for example, a readable and writable nonvolatile storage medium. For example, an SSD (Solid State Drive) or an HDD (Hard Disk Drive) can be applied as the storage device ST.

The controller 30 is configured to control the operation of each driving part provided in the crane 100. The functions of the controller 30 may be implemented, for example, by any hardware or any combination of hardware and software. For example, the controller 30 is formed mainly by a computer including a CPU (Central Processing Unit), a memory device, such as an RAM (Random Access Memory) or the like, a nonvolatile auxiliary memory device, such as an ROM (Read Only Memory) or the like, an interface device for various inputs and outputs, and the like. The controller 30 is configured to implement various functions by loading programs to be installed in the auxiliary memory device into the memory device, and executing the programs on the CPU.

For example, the controller 30 is configured to control the operation of the hydraulic actuator HA of the crane 100 in accordance with the operation performed on the operation device 38, with a control target being the proportional valve 29. Also, the controller 30 may perform an operation support for transfer of a suspended load to a target position on the ground plane in contact with the crane 100 (e.g., a plane of a two-dimensional XY coordinate system). The operation support of the crane 100 may include a fully automatic operation of fully controlling the operation of the crane 100, a semi-automatic operation of partially controlling the operation of the crane 100, and a guidance function of displaying the operation of the crane 100 on the display device D1 (or outputting the operation of the crane 100 from a speaker).

As an example, the crane 100 performs a semi-automatic operation in which the controller 30 automatically performs slewing control and raising/lowering control of the crane 100, while the operator operates a winding-up operation and a winding-down operation of the suspended load. In other words, the controller 30 controls only the slewing operation of the upper slewing body 3 and the raising/lowering operation of the boom 6, thereby moving the boom hook 81 to the target position in the two-dimensional coordinate system. For example, the controller 30 outputs a current to the proportional valve 29 to apply an appropriate magnitude of a pilot pressure to the control valve unit 17. Thus, the crane 100 can automatically control the slewing hydraulic motor 2M and the boom raising/lowering hydraulic motor 31M.

For performing the semi-automatic operation, the controller 30 constructs an acquisition part 301, an operation reception part 302, a display control part 303, a registration part 304, a position recognition part 305, a trajectory generation part 306, and a control part 307 under the execution of the programs performed by the CPU.

The acquisition part 301 is configured to acquire detection results of various sensors provided in the crane 100. For example, the acquisition part 301 is configured to acquire, from the operation sensor 39, an operation signal indicating an operation performed by the operator on the operation device 38. The acquisition part 301 is configured to acquire information of the slewing angular velocity and the slewing angle of the upper slewing body 3 from the slewing sensor S1, information of the raising/lowering of the boom 6 (e.g., the raising/lowering angle) from the boom raising/lowering sensor S2, and information of the length of the wire rope 82 from the length sensor S3. Further, the acquisition part 301 is configured to acquire information (e.g., image information) detected by the peripheral recognition device ES.

When acquiring the information from the various sensors, the acquisition part 301 may calculate the height of the suspended load from the length of the wire rope 82 and the raising/lowering angle of the boom 6. The controller 30 may calculate the position of the suspended load (in two-dimensional coordinates, or three-dimensional coordinates including a height) in accordance with the information of the suspended load detected by the peripheral recognition device ES.

The operation reception part 302 is configured to receive an operation from an operator via one or more of the input device D2 and the operation device 38. For example, the operation reception part 302 is configured to receive a long press of a predetermined button of the operation device 38 for transition to the simple operation mode, which is a mode for performing the semi-automatic operation. The “simple operation mode” is an operation mode for transferring the suspended load from the start position (first position), which is the current position, to a target position (second position) previously registered, in response to receiving an input operation of a slewing operation lever of the operation device 38.

The display control part 303 is configured to perform control to display information on the display device D1. For example, the display control part 303 is configured to display a screen of the simple operation mode in response to receiving an operation for transition to the simple operation mode.

In the simple operation mode, the registration part 304 is configured to register, in the storage device ST, the target position used for transfer of the suspended load. For example, before the operation support, the operator manually operates the upper slewing body 3 and the boom 6 such that the suspending fulcrum 6S, which is the tip of the boom 6, overlaps with the target position in the vertical direction. Then, in a state in which the suspending fulcrum 6S is positioned at the target position, the operator can register the current position of the suspending fulcrum 6S as the target position by pressing the target button. In this manner, by storing the position at which the operator performs the manual operation, the target position can be accurately set in a range in which the boom 6 is movable.

For example, as another registration method, the target position may be calculated (recognized) in accordance with detection information obtained by the peripheral recognition device ES disposed in the crane 100. As still another registration method, a positioning device, such as a GNSS positioning device or the like, may be disposed at the target position, and information of the target position measured by this positioning device may be received. Alternatively, as yet another registration method, the position of the target position may be detected by an external device (an imaging device, a LiDAR sensor, a depth sensor, or any other object recognition sensor) provided outside the crane 100, and information of the position of the target position TP may be received from this external device.

The target position to be recognized may be a position of two-dimensional coordinates in the world geodetic system, or may be a position of three-dimensional coordinates including height information obtained by performing altitude measurement using a pressure sensor. When storing the target position, the registration part 304 may convert the position information to dispose the target position in a crane coordinate system with a reference being the upper slewing body 3 of the crane 100.

The position recognition part 305 is configured to recognize the current position of the tip of the boom 6 and/or the current position of the boom hook 81, which is the lower end of the wire rope 82. The tip of the boom 6 is provided with a point sheave 651 from which the wire rope 82 is suspended, and provided with a sheave bracket 650 configured to support the point sheave 651 to be rotatable (see FIG. 1). In other words, the tip of the boom 6 corresponds to the suspending fulcrum 6S from which the wire rope 82 is suspended from the point sheave 651 downward in the vertical direction and that moves integrally with the boom 6.

For example, the position recognition part 305 can recognize the position of the suspending fulcrum 6S and the position of the lower end of the wire rope 82 (the boom hook 81 and/or the suspended load) in accordance with detection information of the peripheral recognition device ES. Here, the position recognition part 305 may calculate an inclination angle θ of the suspended load (the wire rope 82) described below in accordance with the position of the suspending fulcrum 6S and the position of the suspended load. Alternatively, the position recognition part 305 can recognize the position of the suspending fulcrum 6S in accordance with information from various sensors (e.g., the upper slewing body positioning device PS, the slewing sensor S1, and the boom raising/lowering sensor S2) of the crane 100. Also, for example, the crane 100 may include GNSS positioning devices disposed on the suspending fulcrum 6S and the boom hook 81. The position recognition part 305 can recognize the position of the suspending fulcrum 6S and the position of the lower end of the wire rope 82 in accordance with information measured by the GNSS positioning devices, and can also calculate the inclination angle θ.

The trajectory generation part 306 is configured to generate a target trajectory for automatically transferring the boom hook 81 and the suspended load from the start position (current position) of the suspending fulcrum 6S to the target position in a two-dimensional coordinate system indicating the ground plane in contact with the crane 100. A well-known method may be used for generating the target trajectory. For example, the trajectory generation part 306 generates the target trajectory based on the difference in the slewing angle between the current position of the tip of the boom 6 and the target position, and the difference between the current raising/lowering angle of the boom 6 and the raising/lowering angle when the boom hook 81 reaches the target position.

As an example, in accordance with the start position of the suspending fulcrum 6S, the target position, the slewing ability of the upper slewing body 3, the raising/lowering ability of the boom 6, and the like, the trajectory generation part 306 calculates a target trajectory along which the lower end of the wire rope 82 moves in the minimum possible distance. However, for the generation of the target trajectory, the slewing movement may be prioritized to calculate a target trajectory in which the rising/lowering movement of the boom 6 is reduced. This can suppress vibration caused by the rising/lowering movement of the boom 6 during slewing, the load of the boom 6, and the like.

The control part 307 is configured to control the movement of the upper slewing body 3 and the boom 6 of the crane 100 in accordance with the target trajectory generated by the trajectory generation part 306. For example, the control part 307 controls the upper slewing body 3 and the boom 6 to move the suspending fulcrum 6S along the target trajectory from the start position toward the target position in a two-dimensional coordinate system with a reference being the crane 100.

Also, when the boom hook 81 and the suspended load are moved from the start position to the target position, the control part 307 performs control to cause the position of the suspending fulcrum 6S to lead the position of the lower end of the wire rope 82 (the boom hook 81 and/or the suspended load), and cause the position of the lower end of the wire rope 82 to follow the position of the suspending fulcrum 6S. By the lower end of the wire rope 82 moving following the suspending fulcrum 6S, the sway of the lower end of the wire rope 82 is suppressed (therefore this control may be referred to as sway suppression control). The sway suppression control according to the embodiment will be described below in detail.

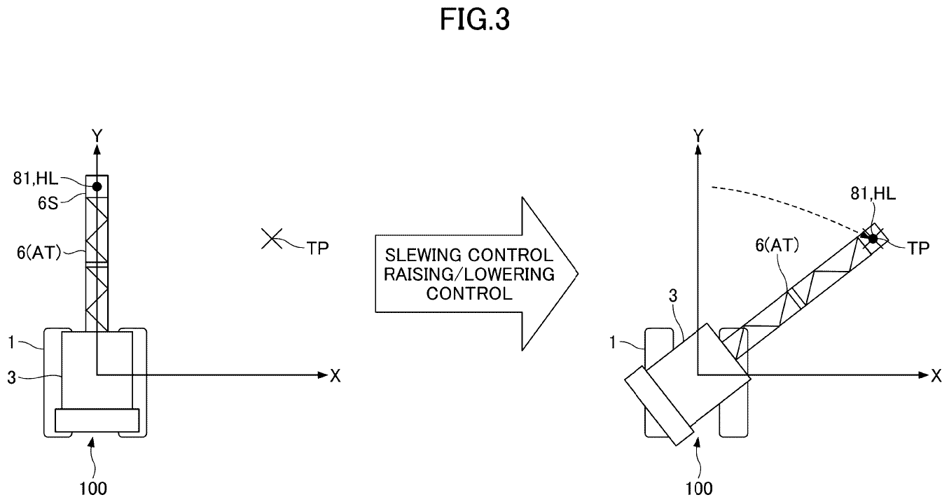

Hereinafter, an operation for automatically moving the suspending fulcrum 6S at the tip of the boom 6 from the start position to the target position TP in the semi-automatic operation of the crane 100 will be described with reference to FIG. 3. FIG. 3 is a plan diagram illustrating the movement of the suspending fulcrum 6S of the crane 100 from the start position to the target position TP. The control to move the suspending fulcrum 6S from the start position to the target position TP may be performed when the suspended load HL is not attached to the boom hook 81 or when the suspended load HL is suspended from the boom hook 81.

Here, the boom hook 81 of the crane 100 (the lower end of the wire rope 82) is basically suspended downward in the vertical direction from the point sheave 651 provided in the suspending fulcrum 6S. Therefore, when the boom hook 81 is moved to the target position TP, it is sufficient to move the suspending fulcrum 6S to overlap with the target position TP in a plan view (on a two-dimensional coordinate system).

Therefore, in the semi-automatic operation, the controller 30 according to the embodiment recognizes the position of the suspending fulcrum 6S and the target position TP before the operations of the upper slewing body 3 and the boom 6. Further, the controller 30 generates a target trajectory from the recognized position (start position) of the suspending fulcrum 6S to the target position TP in a two-dimensional coordinate system or a three-dimensional coordinate system. Then, the controller 30 automatically moves the suspending fulcrum 6S by performing slewing control of the upper slewing body 3 and the raising/lowering control of the boom 6 to be along the target trajectory.

As described above, the position of the suspending fulcrum 6S can be recognized in accordance with information of various sensors of the crane 100 (detection information of the peripheral recognition device ES, or detection information of the upper slewing body positioning device PS, the slewing sensor S1, the boom raising/lowering sensor S2, and the like). Also, the target position TP can be set through registration performed by the registration part 304 as described above. Note that the target position is not limited to a position at which suspending of the suspended load HL is performed or a position at which lowering of the suspended load HL is performed, and may be a relay position during the movement of the lower end of the wire rope 82. That is, the “second position” in the present disclosure may be the position at which suspending of the suspended load HL is performed, the position at which lowering of the suspended load HL is performed, or the relay position during the movement. Similarly, the “first position” in the present disclosure may be the current position of the suspending fulcrum 6S, the relay position, or the position that is set for the start of a movement.

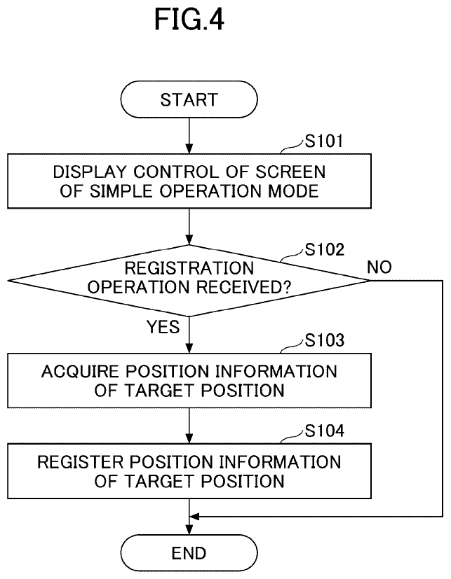

A process of registering the target position TP will be described below with reference to FIG. 4. FIG. 4 is a flowchart illustrating an example of a process through which the target position TP is registered in a simple operation mode in the controller 30 according to the embodiment. When setting the target position TP to which the suspending fulcrum 6S is to be moved, the controller 30 performs, for example, the flowchart illustrated in FIG. 4.

Specifically, the display control part 303, first, performs control to display a screen of the simple operation mode on the display device D1 (S101).

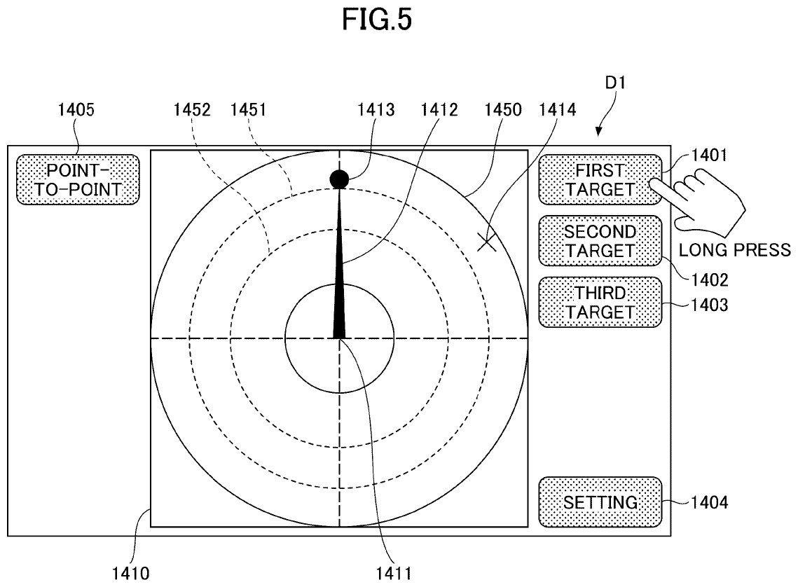

FIG. 5 is a diagram illustrating an example of a screen of the simple operation mode displayed by the display control part 303. For example, a display region 1410, a first target button 1401, a second target button 1402, a third target button 1403, a setting button 1404, and a point-to-point setting button 1405 are displayed on the screen of the simple operation mode.

The display region 1410 displays a coordinate system that two-dimensionally indicates a workable range of the crane 100. A reference position 1411 indicates a slewing center of the crane 100.

A triangular shape 1412 and a circular icon 1413 indicate the current state of the boom 6. Specifically, the triangular shape 1412 indicates the current direction of the boom 6 and the length of the boom 6 in the raised/lowered state, and the circular icon 1413 indicates the suspending fulcrum 6S at the tip of the boom. The length of the triangular shape 1412 from the reference position 1411 to the circular icon 1413 becomes reduced as the boom 6 is raised, and becomes increased as the boom 6 is lowered.

A first circle 1450 is a circle indicating the longest reachable distance of the tip of the boom 6. A second circle 1451 and a third circle 1452 are circles indicated for each of predetermined distances.

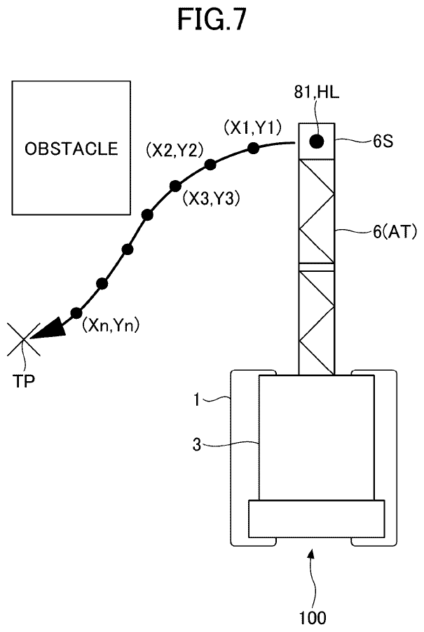

The first target button 1401, the second target button 1402, and the third target button 1403 are buttons configured to dispose the target position TP in the coordinate system (a two-dimensional coordinate system in FIG. 7) with a reference being the crane 100. In other words, in this embodiment, three target positions corresponding to the first target button 1401, the second target button 1402, and the third target button 1403 can be registered. In the display region 1410, the registered target position TP is indicated by an X icon 1414.

For example, when the operator does a long press on the first target button 1401, the acquisition part 301 acquires position information of the target position TP based on the above-described acquisition method of the target position TP. The registration part 304 converts, and then registers, the position information of the target position TP to two-dimensional coordinates with a reference being the crane 100, and displays the X icon 1414 on the display region 1410.

For the operation support of the crane 100, the controller 30 causes pressing of the first target button 1401, the second target button 1402, or the third target button 1403, thereby reading out the registered target position TP and moving the suspending fulcrum 6S to the read-out target position TP. However, the target position TP of the suspending fulcrum 6S does not need to be the final destination. For example, the suspending fulcrum 6S may be moved to the first target position and then moved again to the second target position.

The setting button 1404 is provided for performing various settings. The point-to-point setting button 1405 is used when the boom hook 81 of the crane 100 is moved between two positions.

As illustrated in FIG. 4, the operation reception part 302 determines whether or not a registration operation due to a long press of the first target button 1401, the second target button 1402, or the third target button 1403 has been received (S102). If it is determined that the registration operation is not received (S102: NO), the process is ended without performing any processing.

If the operation reception part 302 determines that the registration operation due to a long press of the first target button 1401, the second target button 1402, or the third target button 1403 has been received (S102: YES), the acquisition part 301 acquires the position information of the target position TP by the above-described method (S103).

The registration part 304 stores the specified position information in the storage device ST in association with the long-pressed target button (the first target button 1401, the second target button 1402, or the third target button 1403) (S104). Here, the display control part 303 displays the acquired position information of the target position TP on the display device D1. For example, the display control part 303 displays the target position TP in a positional relationship with the boom 6 in the display region 1410, which is a coordinate system with a reference being the crane 100. Also, the color of the target button in which the position information is registered may be different from the color of the target button in which the position information is not registered. Thus, the operator can recognize the target button in which the position information is registered when referring to the screen of the simple operation mode. The controller 30 can register the position information of the target position TP by performing the above control.

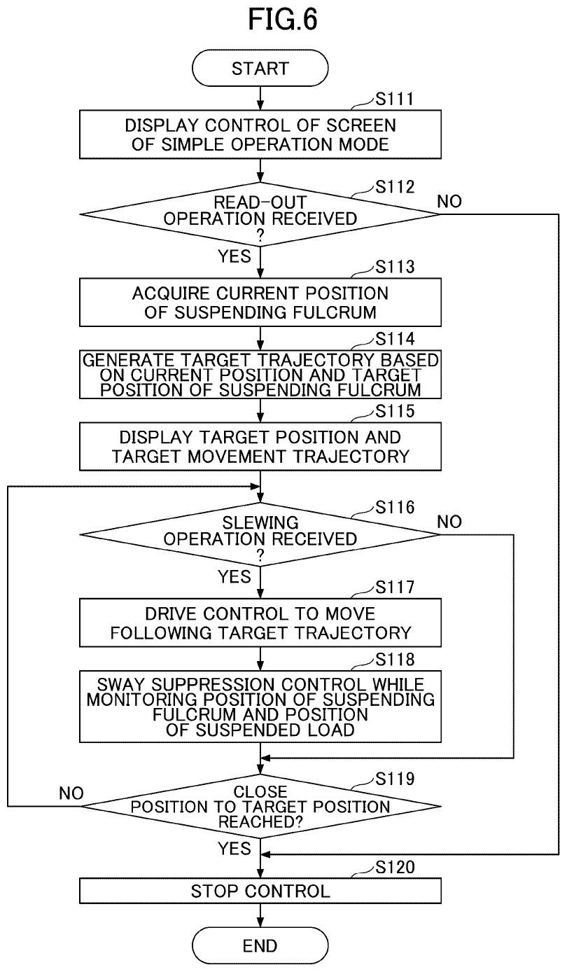

Next, a process of controlling the movement of the boom 6 in the simple operation mode will be described with reference to FIG. 6. FIG. 6 is a flowchart illustrating a process through which the controller 30 performs control of the movement of the boom 6 in the simple operation mode.

The display control part 303 of the controller 30 controls the display device D1 to display a screen of the simple operation mode (S111).

Next, the operation reception part 302 determines whether or not the read-out operation of the position information due to pressing of the target button has been received (S112). If it is determined that the read-out operation of the position information due to pressing of the target button has not been received (S112: NO), the process is ended.

If the operation reception part 302 has determined reception of the read-out operation of the position information (S112: YES), the acquisition part 301 acquires the position information of the current position of the suspending fulcrum 6S provided at the tip of the boom 6 (S113). The acquisition part 301 acquires the position information of the suspending fulcrum 6S by the above-described method of acquiring the position of the suspending fulcrum 6S. In response to acquiring the current position of the suspending fulcrum 6S, the display control part 303 is recommended to perform a calibration to adjust the coordinate system of the crane 100 to the current position of the suspending fulcrum 6S.

Next, when the position information corresponding to the target button pressed by the operator is read out from the storage device ST, the trajectory generation part 306 generates the target trajectory of the suspending fulcrum 6S based on the current position of the suspending fulcrum 6S and the target position TP (S114).

Then, the display control part 303 displays, on the display region 1410, the current position of the suspending fulcrum 6S, the target position TP, and the target trajectory (S115). This enables the operator to confirm the target trajectory when the suspending fulcrum 6S is moved in the semi-automatic operation performed by the controller 30. Therefore, the operator can visually confirm the surroundings of the crane 100 before the start of the semi-automatic operation, and confirm whether or not the boom hook 81 or the like contacts an obstacle when the suspending fulcrum 6S is moved along the target trajectory.

Subsequently, the operation reception part 302 determines whether or not the slewing operation due to the slewing operation lever included in the operation device 38 has been received (S116). When the operation reception part 302 has determined reception of the slewing operation due to the slewing operation lever (S116: YES), the process proceeds to S117.

The control part 307 controls the driving of either or both of the slewing hydraulic motor 2M and the boom raising/lowering hydraulic motor 31M such that the suspending fulcrum 6S moves along the target trajectory (S117). Based on the reception of the slewing operation, the control part 307 moves the suspending fulcrum 6S to the target position TP. Here, the control part 307 may simultaneously perform the slewing control of slewing the upper slewing body 3 at a constant slewing velocity and the raising/lowering control of raising/lowering the boom 6 at a constant raising/lowering velocity, thereby maintaining the position of the suspended load in a height direction.

While the slewing control and the raising/lowering control are being performed, the display control part 303 changes the display in the display region 1410 of the screen of the simple operation mode in accordance with the slewing control and the raising/lowering control. For example, the display control part 303 may change the direction and length of the triangular shape 1412 and the circular icon 1413 in accordance with the movement of the crane 100. Also, the display control part 303 may change the length of the displayed triangular shape 1412, the target position TP, and the target trajectory in accordance with the movement of the crane 100 without changing the direction of the triangular shape 1412.

Then, the crane 100 according to the embodiment performs, in the movement of the suspending fulcrum 6S, the sway suppression control to cause the lower end of the wire rope 82 (the boom hook 81 and/or the suspended load HL) to continuously follow the suspending fulcrum 6S (S118). Thus, the crane 100 can suppress the sway of the wire rope 82 during the movement of the boom 6, and can stably move the boom hook 81 and/or the suspended load HL. Also, while the control to move the suspending fulcrum 6S to the target position is being performed, the operator may monitor for obstacle contact by the boom hook 81 or the suspended load HL, and may perform the winding-up operation or the winding-down operation if the boom hook 81 or the suspended load HL is likely to contact the obstacle. By performing the winding up or winding down in accordance with the operation, the control part 307 can adjust the height of the boom hook 81 or the suspended load, and can avoid contacting the obstacle or the like.

If it is determined that the slewing operation due to the slewing operation lever has not been received (S116: NO), the control part 307 does not control the driving of the slewing hydraulic motor 2M and the driving of the boom raising/lowering hydraulic motor 31M. Also, if the reception of the slewing operation is stopped before the suspending fulcrum 6S moves to the target position TP, the control part 307 stops the slewing control of the upper slewing body 3 and the raising/lowering control of the boom 6. This enables the operator to stop the semi-automatic operation when recognizing, visually or the like, an obstacle or the like at a moving destination of the boom hook 81 and the suspended load.

Then, the control part 307 determines whether or not the suspending fulcrum 6S has reached a position close to the target position TP of the target trajectory (S119). If it is determined that the suspending fulcrum 6S has not reached the position close to the target position (S119: NO), the process returns to S116, and the same process is performed again.

Conversely, if it is determined that the suspending fulcrum 6S has reached the position close to the target position TP of the target trajectory (S119: YES), the control part 307 performs stop control to stop the movement while suppressing the sway of the suspended load HL (S120). By stopping the movement of the suspending fulcrum 6S in accordance with this stop control, the sway of the boom hook 81 or the suspended load HL is stopped at an early stage exactly above the target position TP. Therefore, subsequently, the operator of the crane 100 can perform the winding-down operation of the wire rope 82, thereby smoothly lowering the boom hook 81 or the suspended load HL to the target position TP.

### <Sway Suppression Control>

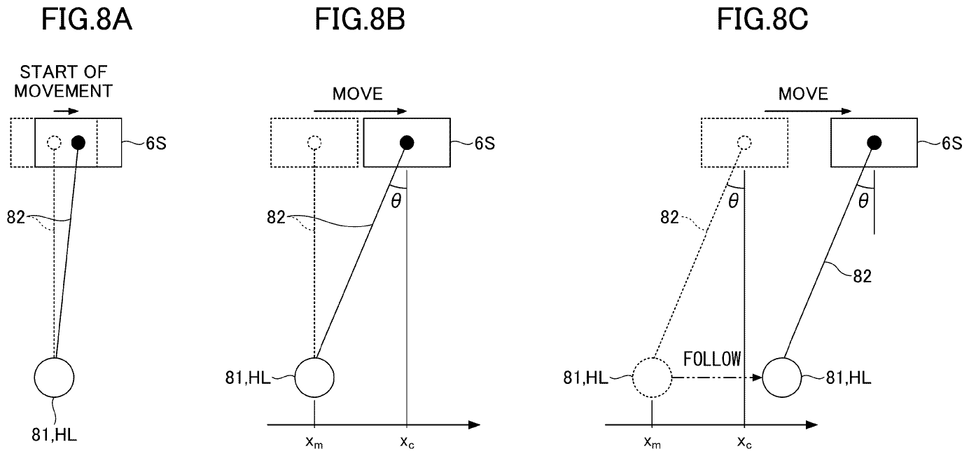

Next, the sway suppression control (S118 in FIG. 6) to suppress the sway of the boom hook 81 or the suspended load HL in the movement of the suspending fulcrum 6S will be described with reference to FIG. 7 and FIGS. 8A to 8C. The following description is based on a case in which the suspended load HL is suspended from the boom hook 81 (therefore, the lower end of the wire rope 82 is also referred to as the suspended load HL). FIG. 7 is a plan view illustrating the target trajectory from the start position to the target position TP in the presence of an obstacle. FIGS. 8A to 8C are first to third explanatory views illustrating a relationship between the position of the suspending fulcrum 6S and the position of the suspended load HL in the sway suppression control.

In automatic transfer (semi-automatic operation) of the suspended load HL, as described above, the control part 307 controls the movement of the suspending fulcrum 6S using the target trajectory generated by the trajectory generation part 306 (see FIG. 2). For the generation of the target trajectory, the acquisition part 301 (see FIG. 2) acquires information of the surroundings of the crane 100 using the peripheral recognition device ES (e.g., the imaging device or the LiDAR sensor) provided in the crane 100, and detects the presence or absence of an object existing in the surroundings, such as an obstacle or the like. When an obstacle exists near the crane 100, the controller 30 reflects the detected obstacle in the recognized coordinates (two-dimensional coordinates, three-dimensional coordinates, or the like), as illustrated in FIG. 7. The trajectory generation part 306 generates a target trajectory for avoiding the detected obstacle in accordance with the position of the obstacle.

The target trajectory for avoiding the obstacle is, for example, a path along which, while the minimum distance is maintained to some extent, the rising/lowering movement of the boom 6 is to be performed only once (the boom 6 is to be raised or lowered only once) and the obstacle is avoidable. However, the target trajectory generated by the trajectory generation part 306 is not limited to this target trajectory. The trajectory generation part 306 may generate a target trajectory for moving the suspending fulcrum 6S to the target position TP in a state in which the upper slewing body 3 is slewed in the reverse direction.

The generated target trajectory can be represented on a two-dimensional coordinate system by a function of positions, e.g., a polynomial function, such as a linear function, a quadratic function, . . . an N-th order function, or the like, or another function, such as a rational function, an irrational function, or the like. The trajectory generation part 306 sets plots at which the position in the target trajectory changes every predetermined time. For example, as illustrated in FIG. 7, the target trajectory has plot 1 (X1, Y1), plot 2 (X2, Y2), plot 3 (X3, Y3), . . . plot N (Xn, Yn). In FIG. 7, the number of plots is reduced for ease of understanding. The actual number of plots of the target trajectory depends on the distance from the start position to the target position, and, for example, may be set to be in a range of several tens of plots to several thousands of plots. In other words, the target trajectory is expressed as a continuous path on a two-dimensional coordinate system by connecting line segments connecting the plots (X coordinates, Y coordinates).

As described above, the suspending fulcrum 6S suspends the boom hook 81 and/or the suspended load HL from the lower end of the wire rope 82 extending downward in the vertical direction (see FIG. 8A). Therefore, the position of the suspending fulcrum 6S can be expressed by an equation of motion of the suspended load HL (the lower end of the wire rope 82) suspended from the suspending fulcrum 6S. This equation of motion is, for example, a linear sum of the position, velocity, and acceleration of the suspended load HL.

For example, in the sway suppression control, an equation of motion of a linear sum as indicated in Equation (1) below is defined between a position of xc and yc of the suspending fulcrum 6S and a position of xm and ym of the suspended load.

$${x}_{c} = {Ax}_{m} + B \dot{{x}_{m}} + C \ddot{{x}_{m}} \qquad Equation ( 1 )$$

$${y}_{c} = {Dy}_{m} + E \dot{{y}_{m}} + F \ddot{{y}_{m}}$$

Here, xm in Equation (1) is a function of time indicating the position of the X coordinate of the suspended load HL, the first derivative of xm is a function of time indicating the velocity of the X coordinate of the suspended load HL, and the second derivative of xm is a function of time indicating the acceleration of the X coordinate of the suspended load HL. Also, ym in Equation (1) is a function of time indicating the position of the Y coordinate of the suspended load HL, the first derivative of ym is a function of time indicating the velocity of the Y coordinate of the suspended load HL, and the second derivative of ym is a function of time indicating the acceleration of the Y coordinate of the suspended load HL.

As described above, Equation (1) has acceleration. This acceleration can express a force applied to the suspended load HL according to the equation of motion. Then, it is possible to understand that the sway of the suspended load HL occurs due to the force applied to the suspended load HL. Therefore, if the target trajectory is expressed by an equation of motion that cancels the force (acceleration) applied to the suspended load HL, the target trajectory can suppress the sway of the suspended load HL and move the suspended load HL.

Therefore, in the sway suppression control, the controller 30 determines values of constants A, B, C, D, E, and F of the linear sum in Equation (1) such that the position of xc and yc of the suspending fulcrum 6S always leads the position of xm and ym of the suspended load HL. The state in which the position of the suspending fulcrum 6S leads the position of the suspended load HL refers to a state in which the suspended load HL (the wire rope 82) is inclined relative to the suspending fulcrum 6S at an appropriate inclination angle θ, as illustrated in FIGS. 8A to 8C. In Equation (1), constants A, B, and C in the right term of xc and constants D, E, and F in the right term of yc may be values that are the same as or different from each other.

While maintaining the suspending fulcrum 6S to be along the target trajectory, the control part 307 performs the slewing control of the upper slewing body 3 and the raising/lowering control of the boom 6 in accordance with the position, velocity, and acceleration of the suspending fulcrum 6S corresponding to the calculated constants A, B, C, D, E, and F. Thus, the suspending fulcrum 6S can move along the line segment connecting the plots of the target trajectory, and furthermore, can be followed by the suspended load HL while suppressing the acceleration applied to the suspended load HL. The controller 30 may correct the target trajectory, previously generated by the trajectory generation part 306, in accordance with the calculation of the position, velocity, and acceleration of the suspending fulcrum 6S for suppressing the sway of the suspended load HL. For example, when the acceleration of the suspended load HL increases, the position of the suspended load HL, the velocity of the suspended load HL, and the like are corrected to the target trajectory in which the acceleration is subtracted. By moving the suspending fulcrum 6S along the corrected target trajectory, the crane 100 can reduce the sway of the suspended load HL in the horizontal movement of the suspended load HL.

Specifically, as illustrated in FIG. 8A, when the suspending fulcrum 6S starts to move at the start position of the suspending fulcrum 6S, the position of the suspending fulcrum 6S moves while the position of the suspended load HL remains unchanged. This is because the inertia of the suspended load HL during stop is maintained. Therefore, the wire rope 82 is slightly inclined relative to a vertical imaginary line of the suspending fulcrum 6S.

Then, as illustrated in FIG. 8B, at the timing the suspending fulcrum 6S is displaced to some extent, the suspended load HL starts to move (the position of the suspended load HL starts to be displaced). As a result, the inclination angle θ of the suspended load HL temporarily overshoots. However, by controlling the movement of the suspending fulcrum 6S as described above, the controller 30 of the crane 100 adjusts the moving velocity of the suspending fulcrum 6S to form the inclination angle θ calculated after the overshoot. As a result, the crane 100 can cause the suspended load HL to follow the suspending fulcrum 6S while maintaining the appropriate inclination angle θ.

That is, as illustrated in FIG. 8C, since the inclination angle θ is substantially maintained when the suspended load HL moves following the suspending fulcrum 6S, the suspended load HL can move following only the target trajectory of the suspending fulcrum 6S while suppressing the acceleration (including a centrifugal force) applied to the suspended load HL. This suppresses the sway of the suspended load HL in a direction other than the moving direction of the suspending fulcrum 6S.

Then, the control part 307 continues to perform the sway suppression control from the start position (current position) of the suspending fulcrum 6S in the previously generated target trajectory to a position close to and in front of the target position TP. Thus, from the start position to the position close to the target position TP, the suspended load HL is induced to move substantially horizontally in accordance with the suspending fulcrum 6S rather than to sway by receiving other external forces. The position close to the target position TP is, for example, a position in front of the target position TP by about 0.1 meters (m) to about 1 m. However, the position close to the target position TP is not a fixed position in terms of control, and may change, for example, in accordance with the moving velocities of the suspending fulcrum 6S and the suspended load HL.

The above description has been made based on an example in which the target trajectory is previously created, and parameters for suppressing the sway are calculated based on the equation of motion of, for example, the position of the suspending fulcrum 6S, the position of the suspended load HL, the velocity of the suspended load HL, the acceleration of the suspended load HL, and the like in the created target trajectory. Thus, the crane 100 can control the movement of the suspending fulcrum 6S to be along the target trajectory, thereby causing the suspended load HL to appropriately follow the suspending fulcrum 6S. However, the above process is by no means a limitation. At the time of generation of the target trajectory, the controller 30 may generate the target trajectory in consideration of parameters of the sway suppression control associated with the acceleration or the like of the suspended load HL. Also, the controller 30 can cause the suspended load HL to follow the suspending fulcrum 6S by controlling the movement of the suspending fulcrum 6S in accordance with the position and time of each plot of the target trajectory.

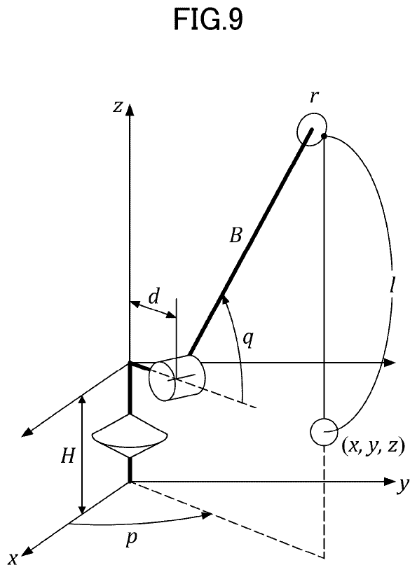

For ease of understanding, FIGS. 8A to 8C illustrate an example in which the suspended load HL moves in a straight line. However, in reality, the crane 100 moves the suspending fulcrum 6S to the target position TP by performing the slewing control of the upper slewing body 3 and the raising/lowering control of the boom 6. Therefore, as illustrated in FIG. 9, the control part 307 converts the position, velocity, and acceleration of the suspending fulcrum 6S along the target trajectory to a rotation angle of an operational axis (e.g., a rising/lowering axis or a slewing axis) of the crane 100, thereby controlling the operation of the crane 100. FIG. 9 is an explanatory diagram illustrating a relationship between a slewing axis p of the crane 100, a rising/lowering axis q of the crane 100, and each parameter of the crane 100.

For example, the rotation angle of the slewing axis p of the crane 100 can be expressed by Equation (2) below.

$$p = {tan}^{- 1} \frac{{y}_{c}}{{x}_{c}} \qquad Equation ( 2 )$$

Here, xc and yc are X-Y coordinate positions of the suspending fulcrum 6S when the suspending fulcrum 6S is moved to the target position TP in a reference coordinate system in which the start position of the crane 100 is zero.

The rotation angle of the rising/lowering axis q of the crane 100 can be expressed by Equation (3) below.

$$q = {cos}^{- 1} \frac{\sqrt{{x}_{c}^{2} + {y}_{c}^{2}} - d - r}{B} \qquad Equation ( 3 )$$

Here, d is a distance from a slewing center of the crane 100 to a base end of the boom 6. r is a radius of a sheave (pulley) at the tip of the boom 6. B is the total length from the base end to the tip of the boom 6.

For the suspending fulcrum 6S to move along the target trajectory, the control part 307 sets amounts of an operation/control of the rotation angle of the slewing axis p in Equation (2) and the rotation angle of the rising/lowering axis q in Equation (3). The control part 307 performs the slewing control of the upper slewing body 3 and the raising/lowering control of the boom 6 in accordance with the set rotation angles of the slewing axis p and the rising/lowering axis q, thereby smoothly moving the suspending fulcrum 6S and successfully causing the suspended load HL to follow the suspending fulcrum 6S.

The crane 100 preferably controls the movement of the suspending fulcrum 6S while monitoring the inclination angle θ of the wire rope 82 in the movement of the suspending fulcrum 6S. Therefore, at the time of the movement of the suspending fulcrum 6S, the position recognition part 305 of the controller 30 detects the positions of the suspending fulcrum 6S, the wire rope 82, the boom hook 81, and/or the suspended load HL using the peripheral recognition device ES, and calculates the inclination angle θ of the wire rope 82. Thus, it is possible to clearly recognize that the suspended load HL follows the suspending fulcrum 6S. However, the detection of the positions or angles of the suspending fulcrum 6S, the wire rope 82, the boom hook 81, and/or the suspended load HL is not limited to the detection using the peripheral recognition device ES. For example, a GNSS positioning device is disposed on the suspending fulcrum 6S and a GNSS positioning device is disposed on the boom hook 81, thereby obtaining positioning information of these positioning devices by the crane 100. This enables recognition of the positions of the suspending fulcrum 6S, the boom hook 81, and/or the suspended load HL. Also, the monitoring of the positions or angles of the boom hook 81 and/or the suspended load HL may be performed using detection information of the peripheral recognition device ES (camera) disposed near the tip (the suspending fulcrum 6S) of the boom 6.

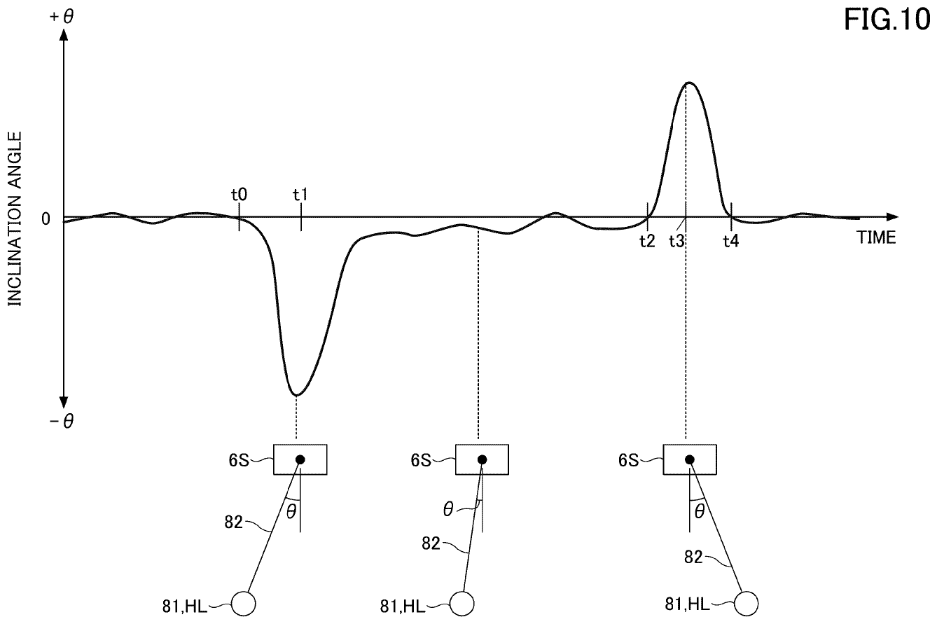

FIG. 10 is a graph illustrating a change over time in the inclination angle θ in the movement of the suspending fulcrum 6S. In the graph of FIG. 10, the horizontal axis indicates time, and the vertical axis indicates the inclination angle θ of the wire rope 82. The inclination angle θ being zero is a state in which the suspended load HL is positioned below the suspending fulcrum 6S in the vertical direction. The inclination angle θ being plus is a state in which the suspended load HL leads the suspending fulcrum 6S. The inclination angle θ being minus is a state in which the suspended load HL follows the suspending fulcrum 6S.

Time to in FIG. 10 is a timing at which the suspending fulcrum 6S starts to move from the start position. In the initial state from time to t0 time t1, the suspended load HL illustrated in FIG. 8A behaves to maintain its position. Therefore, the suspending fulcrum 6S greatly leads the suspended load HL, thereby forming a transition state in which the inclination angle θ greatly changes to the minus side.

After time t1, the suspended load HL starts to follow the suspending fulcrum 6S. Here, the control part 307 controls the moving velocity of the suspending fulcrum 6S such that the suspended load HL, in which the inclination angle θ has changed to the minus side, catches up with the suspending fulcrum 6S to some extent. As a result, the inclination angle θ of the suspended load HL approaches zero from the minus side.

Also, as described above, the control part 307 performs the sway suppression control when causing the suspended load HL to follow the suspending fulcrum 6S. Thus, the suspending fulcrum 6S moves the suspended load HL while maintaining the inclination angle θ of the suspended load HL on the minus side. However, since, at the time of the movement, the suspended load HL sways by receiving external disturbance, vibration of the crane 100, and the like, the suspended load HL may lead the suspending fulcrum 6S.

Time t2 is a timing at which deceleration of the suspending fulcrum 6S is started in accordance with the approach of the suspended load HL to a position close to the target position TP. By decelerating the moving velocity of the suspending fulcrum 6S, the suspended load HL continuing to move by inertia leads the suspending fulcrum 6S. Therefore, at time t3, a transition state occurs in which the inclination angle θ of the wire rope 82 greatly changes to the plus side.

Here, the control part 307 performs stop control to stop the movements of the suspending fulcrum 6S and the suspended load HL while suppressing the sway of the suspended load HL (S120 in FIG. 6). Thus, at time t4, the inclination angle θ of the wire rope 82 moved to the plus side smoothly returns to substantially zero. Moreover, after returning to substantially zero, the state (stop at the target position TP) is maintained.

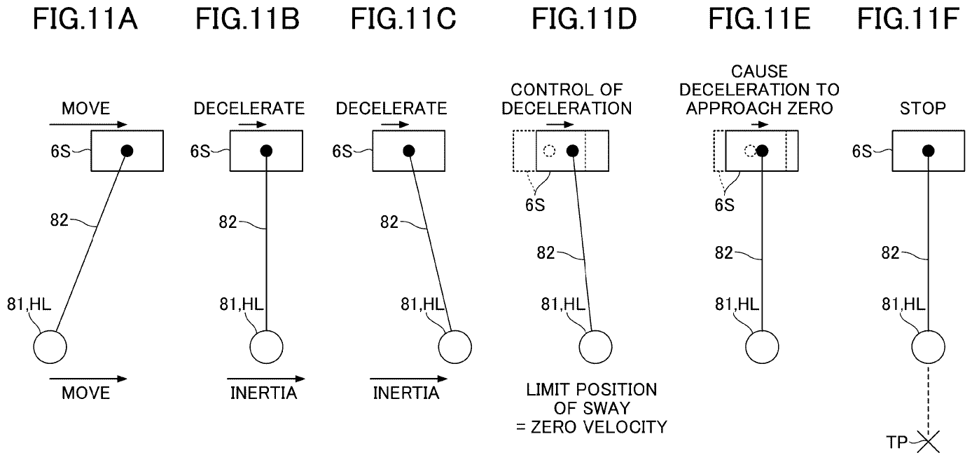

Next, the stop control of the suspending fulcrum 6S will be specifically described with reference to FIGS. 11A to 11F. FIGS. 11A to 11F are first to sixth motion diagrams illustrating a motion of the suspending fulcrum 6S and behaviors of the suspended load HL in the stop control.

As illustrated in FIG. 11A, the suspending fulcrum 6S leads the suspended load HL in accordance with the sway suppression control performed by the crane 100 until before the suspending fulcrum 6S reaches a position close to the target position TP. Also, at the time of the movement of the boom 6, the controller 30 continuously recognizes (monitors) the position of the suspending fulcrum 6S in accordance with detection results of various sensors, and determines whether or not the suspending fulcrum 6S has reached the position close to the target position TP.

When the suspending fulcrum 6S has reached the position close to the target position TP, as illustrated in FIG. 11B, the control part 307 performs control to decelerate the suspending fulcrum 6S. The inertia of the suspended load HL is maintained relative to the moving velocity of the suspending fulcrum 6S. Therefore, the suspended load HL catches up with the suspending fulcrum 6S. Rather than suddenly decelerating the moving velocity of the suspending fulcrum 6S at the position close to the target position TP, the crane 100 may gradually decelerate the moving velocity of the suspending fulcrum 6S from a position away from the position close to the target position TP.

Further, as illustrated in FIG. 11C, the suspended load HL surpasses the suspending fulcrum 6S by inertia, i.e., the suspended load HL leads the suspending fulcrum 6S. In the stop control, the suspending fulcrum 6S is gradually decelerated relative to the leading suspended load HL to catch up with the maximum sway position (the limit position of sway) of the suspended load HL, thereby suppressing the sway of the suspended load HL.

Specifically, as illustrated in FIG. 11D, when the suspended load HL leads the suspending fulcrum 6S, the control part 307 estimates the maximum sway position (the limit position of the sway) of the suspended load HL. The limit position can be estimated based on the moving velocity of the suspended load HL relative to the deceleration of the suspending fulcrum 6S. Then, the control part 307 controls slow deceleration and sudden deceleration of the suspending fulcrum 6S such that the suspending fulcrum 6S overlaps with the estimated limit position of the suspended load HL, thereby moving the suspending fulcrum 6S to the limit position of the suspended load HL. At the limit position of the suspended load HL, the moving velocity of the suspended load HL becomes zero. Therefore, by stopping the suspending fulcrum 6S to coincide with the limit position, it is possible to suppress the suspended load HL swaying in the reverse direction (returning).

In the movement of the suspending fulcrum 6S, the control part 307 preferably performs control to move the suspending fulcrum 6S during a quarter cycle of the cycle in which the suspended load HL sways via the wire rope 82. Thus, during the movement of the suspending fulcrum 6S to the limit position of the sway of the suspended load HL, it is possible to coincide the suspending fulcrum 6S with the limit position of the sway of the suspended load HL.

Further, in the stop control, as illustrated in FIG. 11E, the control part 307 preferably causes the deceleration of the suspending fulcrum 6S to approach zero as the suspending fulcrum 6S approaches the limit position of the sway of the suspended load HL. This enables the suspending fulcrum 6S to smoothly stop at the limit position of the sway of the suspended load HL, and can suppress the sway of the suspended load HL caused by the suspending fulcrum 6S surpassing the limit position of the sway of the suspended load HL.

Further, in the actual movement of the suspending fulcrum 6S, the control part 307 calculates the inertia of the suspended load HL, and adjusts the moving velocity of the suspending fulcrum 6S such that the limit position of the sway of the suspended load HL overlaps with the target position TP. Thus, as illustrated in FIG. 11F, when the suspending fulcrum 6S stops at the limit position of the sway of the suspended load HL, the suspending fulcrum 6S and the suspended load HL exactly overlap with the target position TP. That is, the crane 100 can move the suspended load HL relative to the target position TP in a state in which the sway of the suspended load HL is suppressed.

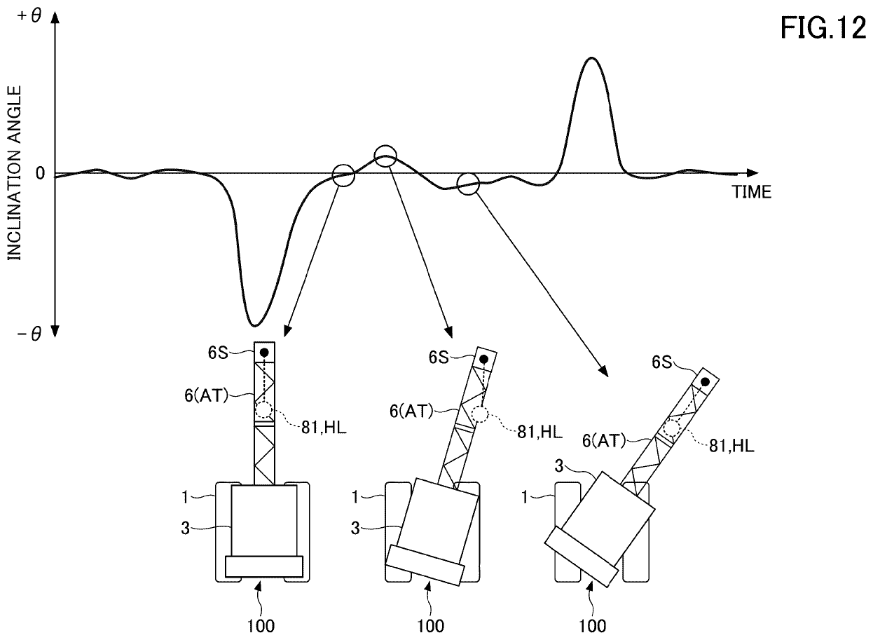

FIG. 12 is a graph illustrating an operation that suppresses the suspended load HL from moving ahead of the suspending fulcrum 6S when, during the movement of the suspension point, the suspended load HL begins to lead. In the graph of FIG. 12, the horizontal axis indicates time, and the vertical axis indicates the inclination angle θ of the wire rope 82.

As described above, the crane 100 performs control to cause the suspended load HL to follow the suspending fulcrum 6S. However, at the time of the actual movement of the suspended load HL, the suspended load HL may lead the suspending fulcrum 6S due to a deviation from the target trajectory of the suspending fulcrum 6S, vibration of the crane 100, external disturbance, and the like. The state in which the suspended load HL leads the suspending fulcrum 6S means that the inclination angle θ of the wire rope 82 changes to the plus side in the graph of FIG. 12. Especially in the sway suppression control to cause the suspended load HL to follow the suspending fulcrum 6S, the inclination angle θ of the actual suspended load HL is adjusted to be maintained to be substantially zero even if the inclination angle θ is positioned on the minus side (see FIG. 10). This increases a possibility that the inclination angle θ of the wire rope 82 changes to the plus side during the movement of the suspending fulcrum 6S.

For example, the controller 30 monitors the inclination angle θ of the wire rope 82 in accordance with the information of the suspending fulcrum 6S and the lower end (the boom hook 81 and/or the suspended load HL) of the wire rope 82, which is acquired by the peripheral recognition device ES. Then, the controller 30 determines whether or not the inclination angle θ of the wire rope 82 changes to the plus side, in other words, whether or not the suspended load HL leads the suspending fulcrum 6S. When the inclination angle θ of the wire rope 82 changes to the plus side, a follow adjustment of increasing the moving velocity of the suspending fulcrum 6S is performed. By this follow adjustment, the suspending fulcrum 6S leads the suspended load HL again. Alternatively, when the controller 30 estimates that the inclination angle θ of the wire rope 82 changes to the plus side (in other words, the suspended load HL leads the suspending fulcrum 6S), the follow adjustment of increasing the moving velocity of the suspending fulcrum 6S may be performed.

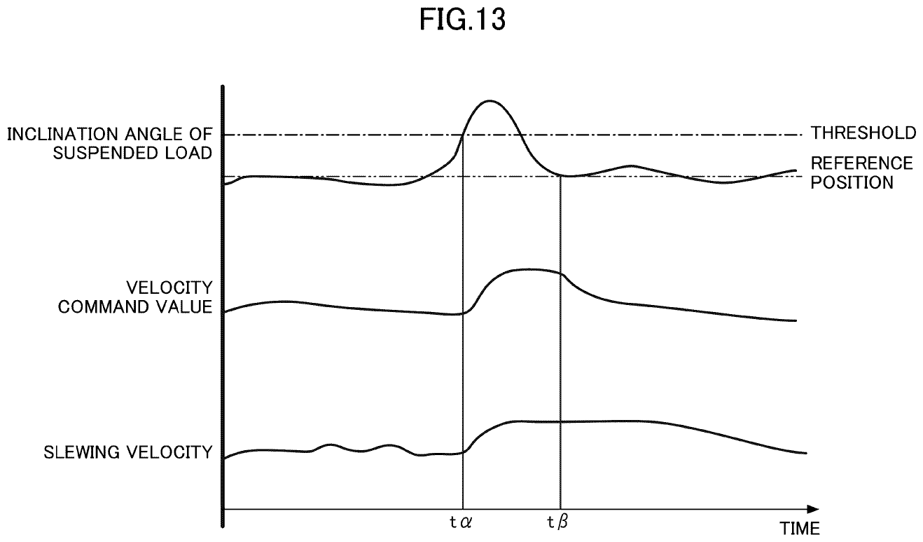

FIG. 13 is a graph illustrating a change in the inclination angle, a change in the velocity command value, and a change in the slewing velocity of the suspended load HL when the follow adjustment is performed in the sway suppression control. As described above, the controller 30 calculates the inclination angle θ of the suspended load HL relative to the suspending fulcrum 6S in accordance with the detection of the peripheral recognition device ES. The controller 30 previously includes a threshold for monitoring the state of the suspended load HL, and determines whether or not the inclination angle θ is equal to or greater than the threshold. Note that a reference position of the inclination angle in the graph is the target inclination angle for maintaining the following of the suspended load HL in the sway suppression control.

The threshold for determining the inclination angle θ may be set to the plus side, the minus side, or zero. For example, if the threshold set on the plus side is used, it is possible to determine a state in which the suspended load HL surely leads the suspending fulcrum 6S. If the threshold set on the minus side is used, it is possible to predict that the suspended load HL surpasses the suspending fulcrum 6S before the suspended load HL leads the suspending fulcrum 6S. Predicting that the suspended load HL surpasses the suspending fulcrum 6S may be performed by determining that the threshold is surpassed in a pattern in which the inclination angle θ greatly changes, in consideration of a change rate of the inclination angle θ.

When it is determined that the inclination angle θ of the suspended load HL has become equal to or greater than the threshold at time to, the control part 307 of the controller 30 changes the velocity command value of the suspending fulcrum 6S in the moving direction. For example, as illustrated in FIG. 13, when the upper slewing body 3 is being slewed rightward, the velocity command value of the rightward slewing is increased from time t1 at which the inclination angle θ has become equal to or greater than the threshold. As a result, the crane 100 increases the moving velocity (slewing velocity) of the tip of the boom 6 supported by the upper slewing body 3. That is, the movement of the suspending fulcrum 6S is controlled to surpass the leading suspended load HL, and the suspended load HL follows the suspending fulcrum 6S again.

After the suspending fulcrum 6S surpasses the suspended load HL at time tβ (after the inclination angle θ reaches the reference position), the controller 30 performs again the sway suppression control to suppress the sway of the suspended load HL by the movement of the suspending fulcrum 6S. If the position of the suspending fulcrum 6S is deviated from the target trajectory due to the follow adjustment, it is possible to correct the target trajectory and perform the slewing control of the upper slewing body 3 and the raising/lowering control of the boom 6 to be along the corrected target trajectory. The controller 30 performs control to gradually decrease the velocity of the suspending fulcrum 6S that has been increased in the velocity to surpass the suspended load HL. Thus, the crane 100 can gradually decrease the velocity of the suspended load HL while maintaining again the positional relationship between the suspending fulcrum 6S and the suspended load HL. This can suppress the sway of the suspended load HL at the time of stop or the like.

The work machine (the crane 100) according to the present disclosure is not limited to the above-described embodiments, and various modified examples are possible. For example, the work machine is not limited to a crane used in a construction work site, and may be a crane disposed in a port or the like (a low floor-type crane, a gate-type crane, or a tower-type crane). Also, the work machine is not limited to the movable crane, and may be a fixed crane. Alternatively, the work machine may be an overhead crane, a bridge crane, or the like, in which a suspending movable portion is moved on a runway. Further, the work machine may be, for example, a crane truck including a crane, or an evacuator having functions of a crane in which a wire rope is used as an attachment of the evacuator.

### MODIFIED EXAMPLE

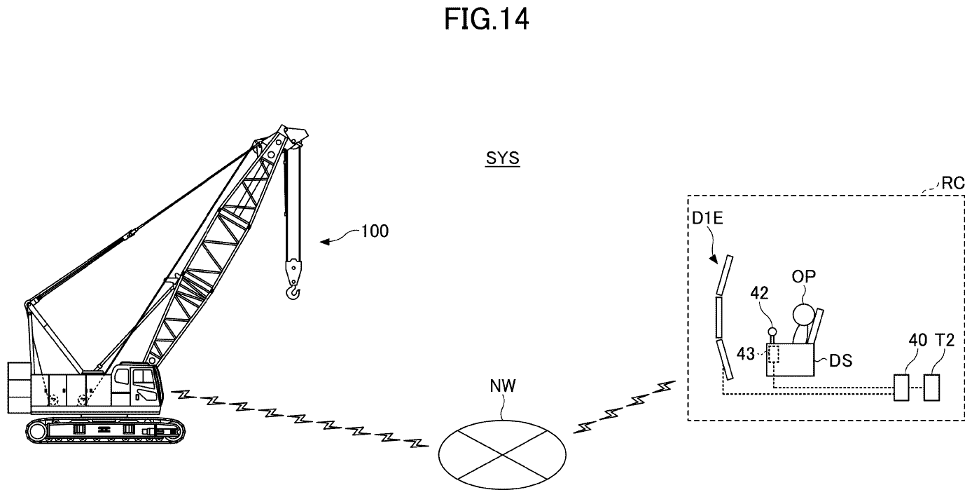

FIG. 14 is a schematic diagram illustrating a configuration example of a remote control system SYS for the crane 100 according to a modified example of the present disclosure. As illustrated in FIG. 14, the remote control system SYS includes a remote control compartment RC. The crane 100 and the remote control compartment RC are connected to each other via a communication line NW to enable communication of information.

The crane 100 transmits detection results of various sensors provided in the crane 100 to the remote control compartment RC using the communication device T1 provided in the crane 100. Further, the crane 100 transmits image information, acquired by an imaging device (not shown), to the remote control compartment RC.

The remote control compartment RC includes a display device DIE, an operation device 42, an operation sensor 43, an operation seat DS, a remote controller 40, and a communication device T2.

The remote controller 40 includes the acquisition part 301, the operation reception part 302, the display control part 303, the registration part 304, the position recognition part 305, the trajectory generation part 306, and the control part 307, which are provided in the controller 30 in the above-described embodiments. The control part 307 is configured to generate a control command for controlling the crane 100, and transmit the generated control command to the crane 100 using the communication device T2.

Therefore, the remote controller 40 is configured to implement the semi-automatic control of the crane 100 in the simple operation mode. Specifically, the remote controller 40 is configured to receive, from the crane 100, position information indicating positions for the movement of the boom 6, and register this position information in a storage device in the remote controller 40. These positions include the position of the suspending fulcrum 6S, the position of the lower end of the wire rope 82, and the information of the target position TP. The remote controller 40 enables the position information to be used as positions for automatically controlling the upper slewing body 3 and the boom 6. The trajectory generation part 306 can generate the target trajectory based on the position information. Also, the display device DIE is configured to display the registered position information and the target trajectory on a display region in which the workable space of the crane 100 is displayed in a two-dimensional coordinate system or three-dimensional coordinate system under the control of the remote controller 40.

Further, when the slewing operation is performed by the operation device 42, the remote controller 40 transmits, to the crane 100, commands for the slewing control of the upper slewing body 3 and the raising/lowering control of a front attachment 7 such that the boom 6 moves to the target position TP along the target trajectory. Thus, the crane 100 moves the boom 6 and the boom hook 81 (the lower end of the wire rope 82) to the target position TP. Here, by performing the sway suppression control (including the stop control, the follow adjustment, and the like), the crane 100 can suppress the sway of the suspended load HL or the boom hook 81 to achieve a stable movement.

In this manner, the crane 100 can be controlled from a remote place by performing the operation in the remote control compartment RC. Therefore, it becomes easier to secure an operator of the crane 100 even if the work site is a remote place.

### CLAUSES

The technical ideas and effects of the present disclosure described in the above embodiments will be described below.

An aspect of the present disclosure is a work machine (the crane 100) including: the wire rope 82 including the lower end (the boom hook 81) configured to hold the suspended load HL; and the suspending fulcrum 6S configured to suspend the wire rope 82 and to be movable. In a case in which the lower end of the wire rope 82 is moved in the horizontal direction from the first position (the start position), which is previously set, to the second position (the target position TP), the work machine is configured to perform control to maintain, from the first position to the position close to the second position, a state in which the suspending fulcrum 6S leads the position of the lower end of the wire rope 82, and the lower end of the wire rope 82 follows the suspending fulcrum 6S.

According to the above, the work machine (the crane 100) can move the suspending fulcrum 6S by controlling the movement of the wire rope 82 to suppress the sway of the lower end of the wire rope 82. Thus, in the control of the movement of the wire rope 82, significant deviation of the lower end of the wire rope 82 from the target trajectory of the suspending fulcrum 6S is suppressed. For example, it is possible to avoid inconveniences, such as, for example, interference of the suspended load HL, held by the wire rope 82, with an obstacle.

Also, the work machine (the crane 100) is configured to: lower the moving velocity of the suspending fulcrum 6S at the position close to the second position (the target position TP), thereby causing the lower end (the boom hook 81) of the wire rope 82 moving by inertia to lead the suspending fulcrum 6S; and subsequently move the suspending fulcrum 6S to overlap with the position of the leading lower end of the wire rope 82 in the vertical direction. With this configuration, the work machine can successfully suppress the sway of the lower end of the wire rope 82 during stop of the suspending fulcrum 6S.

Also, in a case in which the lower end (the boom hook 81) of the wire rope 82 is caused to lead the suspending fulcrum 6S, the work machine (the crane 100) is configured to control the moving velocity and position of the suspending fulcrum 6S such that the limit position of the lower end of the wire rope 82 swayed by the inertia is the second position (the target position TP). With this configuration, the work machine can perform positional control such that the suspending fulcrum 6S and the lower end of the wire rope 82 stop exactly at the target position TP.

Also, in a case in which, during the control of the movement from the first position (the start position) to the position close to the second position (the target position TP), the lower end (the boom hook 81) of the wire rope 82 surpasses the suspending fulcrum 6S or is estimated to surpass the suspending fulcrum 6S, the work machine (the crane 100) is configured to increase the moving velocity of the suspending fulcrum 6S. With this configuration, even if the lower end of the wire rope 82 leads the suspending fulcrum 6S, the work machine can cause again the lower end of the wire rope 82 to follow the suspending fulcrum 6S.

Also, the work machine (the crane 100) is configured to: monitor an inclination angle θ of the wire rope 82 relative to the vertical direction; and based on the inclination angle θ, determine a state in which the lower end (the boom hook 81) of the wire rope 82 surpasses the suspending fulcrum 6S, or estimate that the lower end of the wire rope 82 surpasses the suspending fulcrum 6S. With this configuration, the work machine can easily determine or estimate the state of the lower end of the wire rope 82.

Also, the inclination angle θ of the wire rope 82 is determined by the peripheral recognition device ES acquiring the position of the suspending fulcrum 6S and the position of the lower end of the wire rope 82. With this configuration, the work machine (the crane 100) can easily acquire the inclination angle θ of the wire rope 82, and can smoothly determine whether or not the lower end of the wire rope 82 leads the suspending fulcrum 6S.

Also, the work machine is the crane 100 including a slewing body (the upper slewing body 3) and the boom 6 attached to the slewing body to be able to be raised and lowered, the suspending fulcrum 6S is provided at the tip of the boom 6, and in a case in which the tip of the boom 6 is moved from the first position to the second position, the work machine is configured to maintain a state in which the suspending fulcrum 6S leads a position of the lower end of the wire rope 82 and the lower end of the wire rope 82 follows the suspending fulcrum 6S, while performing the slewing control of the slewing body and the raising/lowering control of the boom 6. With this configuration, the crane 100 can successfully cause the lower end of the wire rope 82 to follow the suspending fulcrum 6S while performing the slewing control and the raising/lowering control.

The work machine (the crane 100) according to the embodiments disclosed herein is exemplary and non-limiting in all respects. The embodiments can be modified and improved in various ways without departing from the scope and intent of claims recited. The matters described in the above embodiments can take any other configuration as long as there is no contradiction, and can be combined as long as there is no contradiction.

What is claimed is:

1. A work machine, comprising:
a wire rope including a lower end configured to hold a suspended load;
a suspending fulcrum configured to suspend the wire rope and to be movable; and
a controller including a memory and a processor coupled to the memory, wherein
in a case in which the lower end of the wire rope is moved in a horizontal direction from a first position, which is previously set, to a second position, the controller is configured to perform control to maintain, from the first position to a position close to the second position, a state in which the suspending fulcrum leads the lower end of the wire rope, and the lower end of the wire rope follows the suspending fulcrum.

2. The work machine according to claim 1, wherein
the controller is further configured to:
lower a moving velocity of the suspending fulcrum at the position close to the second position, thereby causing the lower end of the wire rope moving by inertia to lead the suspending fulcrum; and
subsequently move the suspending fulcrum to overlap with a position of the leading lower end of the wire rope in a vertical direction.

3. The work machine according to claim 2, wherein
in a case in which the lower end of the wire rope is caused to lead the suspending fulcrum, the controller is further configured to control a moving velocity and position of the suspending fulcrum such that a limit position of the lower end of the wire rope swayed by the inertia is the second position.

4. The work machine according to claim 1, wherein
in a case in which, during control of a movement from the first position to the position close to the second position, the lower end of the wire rope surpasses the suspending fulcrum or is estimated to surpass the suspending fulcrum, the controller is further configured to increase a moving velocity of the suspending fulcrum.

5. The work machine according to claim 4, wherein
the controller is further configured to:
monitor an inclination angle of the wire rope relative to a vertical direction; and
based on the inclination angle, determine a state in which the lower end of the wire rope surpasses the suspending fulcrum, or estimate that the lower end of the wire rope surpasses the suspending fulcrum.

6. The work machine according to claim 5, wherein
the inclination angle of the wire rope is determined by a peripheral recognition device acquiring a position of the suspending fulcrum and a position of the lower end of the wire rope.

7. The work machine according to claim 1, wherein
the work machine is a crane including a slewing body and a boom attached to the slewing body to be able to be raised and lowered,
the suspending fulcrum is provided at a tip of the boom, and
in a case in which the tip of the boom is moved from the first position to the second position, the controller is configured to maintain a state in which the suspending fulcrum leads the lower end of the wire rope, and the lower end of the wire rope follows the suspending fulcrum, while the controller performing slewing control of the slewing body and raising and lowering control of the boom.
